(19) United States
(12) Patent Application Publication
(10) Pub. No.: US 2001/0052072 A1
(43) Pub. Date: Dec. 13, 2001

(54) Encryption of payload on narrow-band IP links

(76) Inventor: Stefan Jung, Brottby (SE)

Correspondence Address: Richard J. Moura, Jenkens & Gilchrist, P.C., 3200 Fountain Place, 1445 Ross Avenue, Dallas, TX, 75202-2799, US

(21) Appl. No.: 09/751,156

(22) Filed: Dec. 27, 2000

Related U.S. Application Data
(60) Provisional application No. 60/177,825, filed on Jan. 25, 2000.

(51) Int. Cl. H04L 9/00

(52) U.S. Cl. 713/160; 713/181

(57) ABSTRACT

Method and apparatus for synchronizing the transmitting side and the receiving side in an IP network that uses a stream encryption algorithm are disclosed. A sequence number is introduced into the payload of each packet at the transmitting side and transmitted with the packets. Upon receipt at the receiving side, the sequence number is extracted from the payload and used to synchronize the receiving side to the transmitting side. An error detection mechanism is used to detect when the synchronization is lost and a recovery procedure is initiated. The length of the sequence number is made sufficiently long to cope with any jitter variations in the IP network. This sequence number length is dynamically adjustable based on the amount of jitter detected in the network.

This Application for Patent claims the benefit of priority from, and hereby incorporates by reference the entire disclosure of, co-pending U.S. Provisional Application for U.S. Pat. Ser. No. 60/177,825, filed Jan, 25, 2000.

### BACKGROUND

1. Field of the Invention

The invention is related to IP networks and, more particularly, to the encryption of voice and speech data on narrow-band IP links.

2. History of the Related Art

The tremendous success of the Internet has made it desirable to expand the use of the Internet Protocol (IP) to a wide variety of applications. For example, there is presently an effort to expand IP to applications such as mobile radio access networks that have heretofore used connection-oriented protocols. The objective is, of course, to be able to use the Internet as an extension of such mobile radio access networks to transport real-time voice and speech data.

Speech data has been transported across the Internet using IP-based transport layer protocols such as the User Datagram Protocol (UDP) and the Real-time Transport Protocol (RTP). In a typical one of such applications, speech is converted into digital data, which is then assembled into data packets that are suitable for transport across an IP network using one of the IP-based transport layer protocols.

FIG. 1 illustrates a pertinent portion of an exemplary IP network 10. As can be seen, the IP network 10 includes a mobile station 11 providing speech data over a radio link 12 to a radio base station 13, which is connected via land lines 14 to a radio access network 15. The radio link 12 may be any air interface between the mobile station 11 and the radio base station 13, such as a cellular link. The radio access network 15 may include a layer of communications protocol such as the Global System for Mobile Communications (GSM), or the like, that can be used to transfer the speech data to and from the mobile station 11. A network connection 16 connects the radio access network 15 to an IP backbone network such as the Internet 17.

Speech data is presently transferred to and from the radio access network 15 using circuit-switched protocols. It is expected that in future applications, the speech data will be transferred over the radio access network 15 using IP-based protocols in order to take advantage of the increasingly widespread use of IP. Speech data transferred in this manner is transmitted in burst of packets, each packet having a header portion and a payload portion.

Transporting speech data over the IP network 10, however, raises a number of issues. For one thing, the IP network 10 is relatively unsecured, rendering the speech data traffic vulnerable to access by a third party. The speech data may subsequently be tampered with or otherwise modified and then forwarded on, thereby compromising the integrity of the speech data. Any data protection scheme contemplated for the IP network 10, however, must be bandwidth efficient in order to be feasible because the radio access network 15 is often bandwidth limited. As is generally known, the cost associated with bandwidth is significantly higher in the radio access network 15 than in the IP backbone network 17.

One method currently being proposed to safeguard speech data transferred over the IP network 10 is a set of protocols called IP Security (IPsec) that protects the data at the IP transport layer. However, the nature of IPsec is such that it would introduce a tremendous bandwidth overhead for real-time IP-based speech traffic over narrow band links.

Another method for safeguarding speech data is to use an application layer encryption algorithm at the sending side to encrypt the payload. The encrypted payload can then be decrypted at the receiving side. Encryption keys for the algorithm may be exchanged between the two sides in advance through a secure transfer mechanism when the initial connection between the sending side and the receiving side is made.

Due to the above mentioned bandwidth limitation of the radio access network, the encryption algorithm used for speech data transfer is preferably a stream encryption algorithm. Stream encryption algorithms encrypt data in small units (e.g., a bit, a byte, a packet) and are generally much faster for encrypting a continuous stream of data than block encryption algorithms that encrypt data in large blocks. Moreover, stream encryption algorithms have better error resiliency than block encryption algorithms. For example, a single-bit error in a stream encryption algorithm would yield only one error upon decryption, whereas a single-bit error in a block encryption algorithm would generate multiple errors upon decryption. This error resiliency may be important in the radio access network 15, as the bit-error rates therein can be substantially higher than in the IP backbone network 17. For example, radio access networks 15 that are built using several microwave links can be particularly susceptible to high bit-error rates.

A requirement of stream encryption algorithms is that the transmitting side and the receiving side be synchronized in order for the encryption and decryption to work properly. Specifically, the data must be decrypted in the same order or sequence in which it was encrypted. However, such synchronization is not only difficult to employ and maintain in the IP network 10, but can also consume a significant amount of bandwidth (e.g., 7-10% using RTP).

Accordingly, it is desirable to provide a bandwidth efficient way to protect IP-based speech data in the IP network 10. More particularly, it is desirable to provide a way to synchronize the transmitting side and the receiving side in an IP network 10 that uses a stream encryption algorithm.

### SUMMARY OF THE INVENTION

The present invention is directed to a method and an apparatus for synchronizing the transmitting side and the receiving side in an IP network that uses a stream encryption algorithm. A sequence number is introduced into the payload of each packet at the transmitting side and transmitted with the packets. Upon receipt at the receiving side, the sequence number is extracted from the payload and used to synchronize the receiving side to the transmitting side. An error detection mechanism is used to detect when the synchronization is lost, and a recovery procedure is initiated. The length of the sequence number is made sufficiently long to cope with any jitter variations in the IP network. This sequence number length is dynamically adjustable based on the amount of jitter detected in the network.

In one aspect, the invention is related to a method of synchronizing encrypted data in an Internet Protocol based network. The method comprises the steps of encrypting a data packet to be transmitted, generating a sequence number associated with the encrypted data packet, and transmitting the encrypted data packet together with the sequence number via an Internet Protocol based link.

In another aspect, the invention is related to an apparatus for synchronizing encrypted data in an Internet Protocol based network. The apparatus comprises an encryption/decryption module configured to encrypt a data packet to be transmitted, a sequence number processor in the encryption/decryption module configured to generate a sequence number associated with the encrypted data packet, and a transceiver module connected to the encryption/decryption module configured to transmit the encrypted data packet together with the sequence number via an Internet Protocol based link.

In yet another aspect, the invention is related to an apparatus for synchronizing encrypted data in an Internet Protocol based network. The apparatus comprises an encryption/decryption module configured to encrypt a data packet to be transmitted, a sequence number processor in the encryption/decryption module configured to generate a sequence number associated with the encrypted data packet, and a transceiver module connected to the encryption/decryption module configured to transmit the encrypted data packet together with the sequence number via an Internet Protocol based link. The sequence number processor is further configured to extract a sequence number from a received encrypted data packet, and the encryption/decryption module is further configured to decrypt the encrypted data packet based on a value of the extracted sequence number. An error detection module is configured to check the decrypted data packet for errors and to cause an error message to be sent if errors are detected in a predetermined number of data packets. The error detection module is further configured to initiate a data recovery procedure upon detecting that errors have occurred in the predetermined number of data packets. The sequence number processor is also configured to reset the sequence number to an initial value after initiation of the data recovery procedure and to issue a sequence number reset notification message after the sequence number is reset. The sequence number processor is further configured to set a length of the sequence number based on an amount of jitter in the Internet Protocol based link, and to dynamically adjust the length of the sequence number to compensate for changes in the amount of jitter in the Internet Protocol based link.

### BRIEF DESCRIPTION OF THE DRAWINGS

A more complete understanding of the method and apparatus of the present invention may be had by reference to the following Detailed Description in conjunction with the Drawings, wherein:

FIG. 1 is a high level illustration of a prior art communications network;

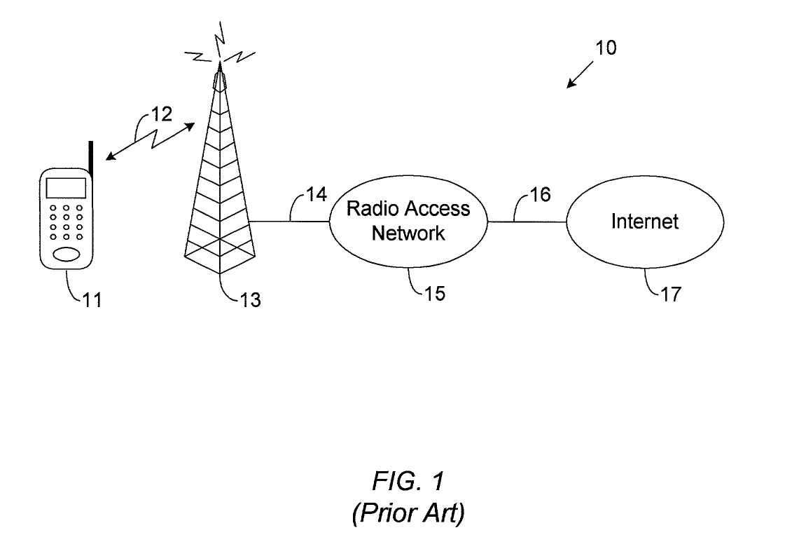

FIG. 2 is a functional block diagram of a transmitter and a receiver according to one embodiment of the present invention;

FIG. 3 is an illustration of a data packet according to one embodiment of the present invention;

FIG. 4 it is a flowchart of an encryption method according to one embodiment of the present invention;

FIG. 5 is a flowchart of a decryption method according to one embodiment of the present invention; and

FIG. 6 is a flowchart of a method of adjusting the sequence number length according to one embodiment of the present invention.

### DETAILED DESCRIPTION OF THE EXEMPLARY PREFERRED EMBODIMENTS

Following is a detailed description of the exemplary preferred embodiments of the present invention with reference to the Drawings, wherein like numerals refer to like and corresponding parts.

As mentioned earlier, it is desirable in a stream encryption algorithm to synchronize the transmitting side and the receiving side as much as possible, and to do so in a bandwidth efficient manner. According to one exemplary embodiment of the present invention, a sequence number may be used to synchronize the transmitting side and the receiving side. In such an arrangement, the sequence number can serve as an indicator of the order or position of a particular data packet in a burst of packets for encryption/decryption purposes.

The sequence number may be appended to the encrypted payload of a speech data packet and then transmitted along with the packet. In some cases, the payload is encoded or compressed prior to encryption in order to minimize the size of the data packet. At the receiving side, the sequence number may be extracted from the payload and used to synchronize the two sides. The encrypted packet is subsequently decrypted into its compressed form and then decoded or decompressed into its original form. The sequence number itself, however, is neither encrypted nor encoded and, therefore, does not need to be decrypted or decoded.

The length of the sequence number may be adjusted as needed based on a number of known statistical quality factors in the network. The updated sequence number length may be communicated to the network using in-band or out-band signaling.

If synchronization between the transmitting side and the receiving side should become lost (as manifested by consecutive corrupted data packets), then the receiving side may notify the transmitting side of this condition via an error message. Upon receiving such an error message, the transmitting side may initiate a data recovery procedure including informing the receiving side that the sequence number will be restarted at a certain data packet or the next burst of data packets.

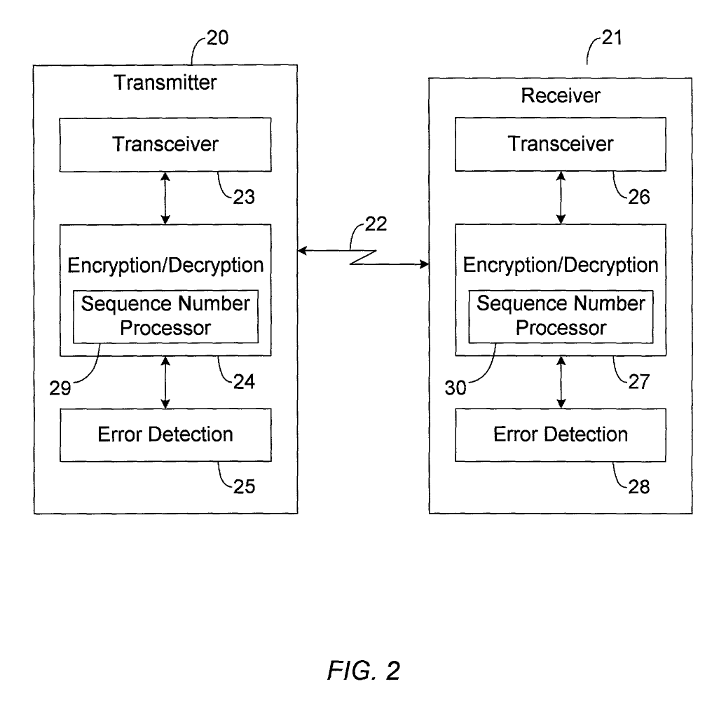

FIG. 2 is a functional block diagram of a typical transmitter unit 20 and receiver unit 21 in the IP network 10. The transmitter unit 20 may be located, for example, in the radio access network 15 at one end (e.g., the radio base station end), and the receiver unit 21 may be located in the radio access network 15 at the other end (e.g., the IP backbone network end), or vice versa. Alternatively, the transmitter unit 20 may be part of the mobile station 11 and the receiver unit 21 may be part of the radio access network 115, or vice versa. Note that the labels “transmitter” and “receiver” are used herein for purposes of convenient reference only, and that each of the transmitter unit 20 and the receiver unit 21 is fully capable of both transmitting and receiving signals in the IP network 10. Furthermore, those of ordinary skill in the art will understand that such a transmitter unit 20 and receiving unit 21 and their constituent components (described later herein) may be implemented as software, hardware, or a combination of both software and hardware.

An IP link 22 connects the transmitter unit 20 to the receiver unit 21. The IP link 22 may include a radio interface such as a cellular link or a microwave link, a wired connection such as an E1 or T1 connection, or any other type of connection that is capable of carrying IP-based speech data packets between the transmitter unit 20 and receiver unit 21.

The transmitter unit 20 has a number of functional components, including a transceiver module 23, an encryption/decryption module 24, and an error detection module 25. The receiver unit 21 likewise has a number of functional components, including a transceiver module 26, an encryption/decryption module 27, and an error detection module 28. Each of the encryption/decryption modules 24 and 28 has a number of functional components including a sequence number processor 29 or 30, respectively. In general, the components of the transmitter unit 20 perform the same function as their counterparts in the receiver unit 21. Therefore, only the functions of the components of the transmitter unit 20 will now be described.

The transceiver module 23 of the transmitter unit 20 is primarily responsible for sending and receiving signals between the transmitter unit 20 and the receiver unit 21. The tasks performed by the transceiver module 23 include all link level and physical level (e.g., Layer 1 and Layer 2) related tasks.

The encryption/decryption module 24 is primarily responsible for encrypting the outgoing speech data packets and decrypting the incoming speech data packets. In one embodiment, a stream encryption algorithm is used by the encryption/decryption module 24 to encrypt and decrypt the data packets. Note, however, that the specific type of stream encryption algorithm used is not important to the invention, and that any known or yet to be developed stream encryption may be used without departing from the scope of the invention. The tasks performed by the encryption/decryption module 24 include such things as performing certain mathematical/logical operations on the data (depending on the type of encryption used), padding the data where applicable, and other tasks related to the encryption/decryption process.

Generating and extracting the sequence number is the primary responsibility of the sequence number generator 29. During data encryption, the sequence number processor 29 has the primary responsibility for generating a different sequence number for each data packet to be encrypted. The generated sequence number is then associated with that particular data packet and is transmitted with that packet in the payload thereof. In some embodiments, the sequence numbers are increased numerically by one's with each data packet, but they may certainly be increased by two's, three's, four's, or some other increment without departing from the scope of the invention.

During data decryption, the sequence number processor 29 has the primary responsibility for extracting the sequence number from the payload of the data packet to be decrypted. The sequence number may thereafter serve as an indicator of the specific order or position of the packet in the burst of packets so that an appropriate iteration of the encryption/decryption process may be applied to the encrypted data. Thus, for example, if one or more data packets were somehow received out of order, the encryption/decryption module 27 of the receiver unit 21 can use the sequence numbers of the packets to correctly reorder the packets. The sequence numbers may also be used to determine if any data packets were lost during transmission, as may be indicated by missing sequence numbers. Such an arrangement can help ensure that the transmitter unit 20 and the receiver unit 21 stay synchronized with each other in a loose sort of way.

The length of the sequence number should be as short as possible for bandwidth efficiency purposes, but sufficiently long to compensate for any jitter variation or other quality factors in the network connections. In one embodiment, the length of the sequence number can be determined statistically from the operation and maintenance of the network, i.e., if the network experiences a large amount of jitter on average, then the length of the sequence number can be made longer. For example, if the average jitter variation is 50 ms and the data packet has a 20-ms payload, then the sequence number should be made at least three bits long.

Furthermore, the length of the sequence number may be dynamically adjusted. For instance, if the quality conditions in the IP network change so that a shorter length sequence number is permitted or a longer length sequence number is required, then the network operator can reconfigure the IP network to use a longer or shorter sequence number. Conditions that can cause a change in the length of the sequence number include, for example, a change in the amount of jitter, signal-to-noise ratio, received signal strength indicator (RSSI), and other known network quality factors.

The new length of the sequence number can be updated to the various transmitter/receiver units in the IP network using in-band or out-band signaling. These updates can occur at the same time that the encryption keys are distributed. In general, the encryption keys need to be updated every so often for security purposes and then distributed to the various transmitter/receiver units in the network. One mechanism that can be used to distribute the keys is the Internet Key Exchange (IKE). By updating the length of the sequence number together with the encryption keys, the rate at which the length of the sequence number is adapted can be the same as the rate at which the encryption keys are adapted.

Alternatively, the length of the sequence number to be used may be determined without employing any signaling. For example, the speech coding algorithm that is used in the network relies on a plurality of known parameters. One of these parameters is the length of the encoded payload. If the sequence number is appended or otherwise attached to the encoded payload, then the length of the sequence number is simply the difference between the actual length of the received payload and the expected length thereof.

Checking the correctness of the received speech data packets is the primary responsibility of the error detection module 25. The error detection module 25 performs a variety of tasks such as verifying, for example, the parity bits, the checksums, or the cyclic redundancy codes of the decoded data to make sure that the data was decoded properly and that no error occurred during transmission. Furthermore, if a predetermined number of packets (e.g., three consecutive packets) are found to be corrupted or otherwise defective, the error detection module 25 may conclude that the problem lies in the encryption/decryption process. In that case, the error detection module 25 may cause a predetermined error message to be sent via in-band or out-band signaling to notify the transmitter unit that synchronization has been lost. On the other hand, if the error detection unit 25 were to receive such an error message, it may thereafter initiate a data recovery procedure to recover the data.

Once a data recovery procedure is initiated, the sequence number processor 29 resets the sequence number back to its initial value. The sequence number processor 29 may then cause a sequence number reset message to be transmitted (via in-band or out-band signaling) indicating that the sequence number will restart beginning with, e.g., a certain data packet or the next burst of packets. Such an arrangement allows the transmitting and receiving sides to become resynchronized once again.

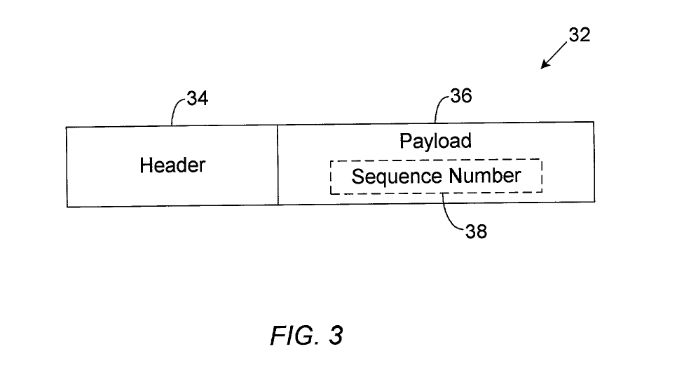

Turning now to FIG. 3, an exemplary data packet 32 is shown. The exemplary data packet 32 includes a header section 34 and a payload section 36. The header section contains standard header information such as the origination and destination addresses of the packet, the type of formatting used, the particular transport layer protocol used, etc. The payload section 36 contains the data to be transported such as encoded speech data. In accordance with one embodiment of the present invention, the payload section 36 also includes a sequence number 38. As mentioned previously, the sequence number 38 may be appended, attached, inserted into, or otherwise made a part of the payload section 36. In addition, whereas the other data in the payload is encoded and then encrypted, the sequence number 38 is neither encoded nor encrypted. In this way, the sequence number 38 can be easily extracted from the payload section 36 and used to synchronize the transmitter unit and the receiver unit.

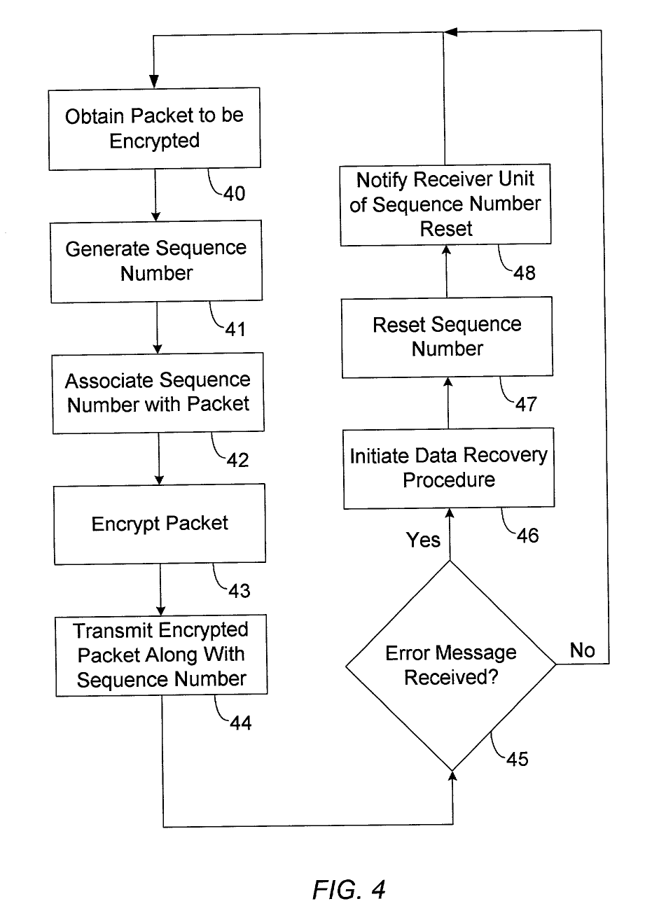

FIG. 4 illustrates a method, according to one embodiment of the present invention, that can be used to transmit speech data in an IP network. At step 40, the data packet that is to be encrypted is obtained in the transmitter unit. A sequence number is generated for the data packet at step 41. If the packet that is to be encrypted is the very first packet of the burst, then it is understood that the sequence number that is generated will be the initial sequence number. At step 42, the sequence number is associated or otherwise assigned to the data packet to be encrypted. The data packet is then encrypted at step 43 using some known or yet to be developed stream encryption technique. At step 44, the encrypted data packet is transmitted along with the associated sequence number. At step 45, a determination is made to see whether an error message has been received from the receiver unit. If yes, then some known data recovery procedure can be initiated at step 46. At step 47, the sequence number is reset to its initial value. The transmitter unit then informs the receiver unit at step 48 (via in-band or out-band signaling) that the sequence number will be restarted beginning with a certain data packet or with the next burst of data packets. The method then begins again at step 40. If no, then the method simply continues at step 40.

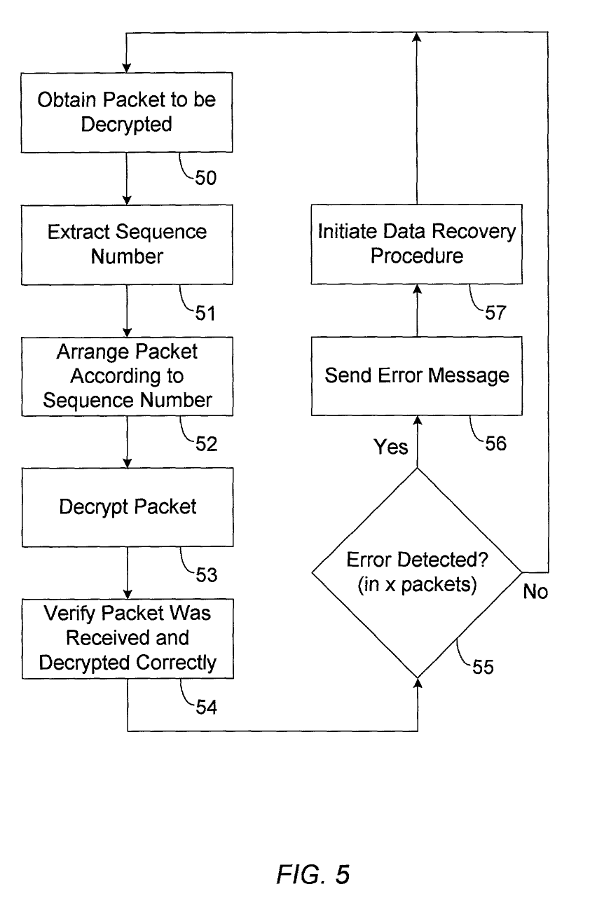

Turning now to FIG. 5, a method of receiving encrypted data packets according to one embodiment of the present invention is shown. At step 50, an encrypted data packet to be decrypted is obtained in the receiver unit. The sequence number is extracted from the payload of the data packet at step 51. The data packet is then ordered or otherwise arranged in its proper place at step 62, based on the extracted sequence number. The ordering here should be identical to the ordering at the transmitter unit by virtue of the use of the sequence number. At step 53, the data packet is decrypted. At step 54, the decrypted data packet is checked for errors that may have occurred during decryption and/or decoding. A determination is made at step 55 to see whether an error was detected in a predetermined number of data packets. If yes, then an error message is sent at step 56 from the receiving unit to the transmitting unit. A known data recovery procedure is initiated at step 57 to try and recover any lost data, and the method begins again at step 50. If no, then the method simply continues at step 50.

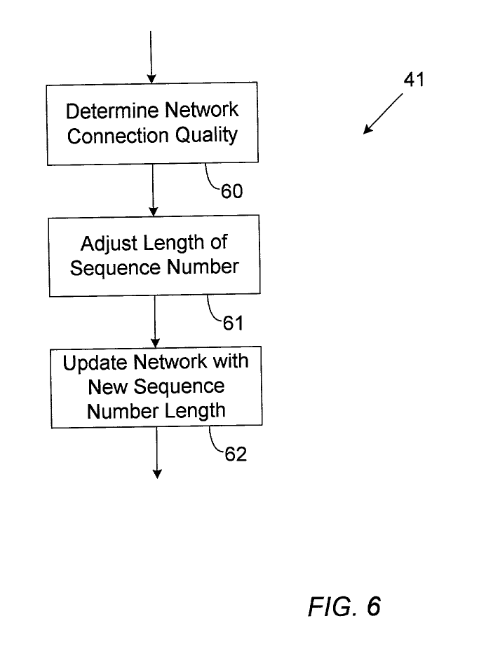

FIG. 6 illustrates in more detail one aspect of the sequence number generating step, step 41, of the method shown in FIG. 6. At step 60, a determination is made as to the quality of the IP link. This determination may be made statistically using factors such as the average amount of jitter in the network, signal-to-noise ratios, RSSI measurements, etc. The length of the sequence number is thereafter adjusted as needed at step 61. The new sequence number length is then signaled to the various transmitter/receiver units in the network at step 62.

Although a preferred embodiment of the method and apparatus of the present invention has been illustrated in the accompanying Drawings and described in the foregoing Detailed Description, it will be understood that the invention is not limited only to the embodiment disclosed, but is capable of numerous rearrangements, modifications and substitutions without departing from the spirit of the invention as set forth and defined by the following claims.

What is claimed is:

1. A method of synchronizing encrypted data in an Internet Protocol based network, comprising the steps of:
encrypting a data packet to be transmitted;
generating a sequence number associated with said encrypted data packet; and
transmitting said encrypted data packet together with said sequence number via an Internet Protocol based link.

2. The method according to claim 1, further comprising receiving said encrypted data packet together with said sequence number and decrypting said encrypted data packet based on a value of said sequence number.

3. The method according to claim 2, further comprising checking said decrypted data packet for errors and sending an error message if errors are detected in a predetermined number of data packets.

4. The method according to claim 3, further comprising initiating a data recovery procedure after reception of said error message.

5. The method according to claim 4, further comprising resetting said sequence number to an initial value after initiating said data recovery procedure.

6. The method according to claim 5, further comprising issuing a sequence number reset notification message after resetting said sequence number.

7. The method according to claim 1, further comprising setting a length of said sequence number based on an amount of jitter in said Internet Protocol based link.

8. The method according to claim 7, further comprising dynamically adjusting said length of said sequence number to compensate for changes in said amount of jitter in said Internet Protocol based link.

9. An apparatus for synchronizing encrypted data in an Internet Protocol based network, comprising:
an encryption/decryption module configured to encrypt a data packet to be transmitted;
a sequence number processor in said encryption/decryption module configured to generate a sequence number associated with said encrypted data packet; and
a transceiver module connected to said encryption/decryption module configured to transmit said encrypted data packet together with said sequence number via an Internet Protocol based link.

10. The apparatus according to claim 9, wherein said sequence number processor is further configured to extract a sequence number from a received encrypted data packet.

11. The apparatus according to claim 10, wherein said encryption/decryption module is further configured to decrypt said encrypted data packet based on a value of said extracted sequence number.

12. The apparatus according to claim 11, further comprising an error detection module configured to check said decrypted data packet for errors and to cause an error message to sent if errors are detected in a predetermined number of data packets.

13. The apparatus according to claim 12, wherein said error detection module is further configured to initiate a data recovery procedure upon detecting that errors have occurred in said predetermined number of data packets.

14. The apparatus according to claim 13, wherein said sequence number processor is further configured to reset said sequence number to an initial value after initiation of said data recovery procedure.

15. The apparatus according to claim 14, wherein said sequence number processor is further configured to issue a sequence number reset notification message after said sequence number is reset.

16. The apparatus according to claim 9, wherein said sequence number processor is further configured to set a length of said sequence number based on an amount of jitter in said Internet Protocol based link.

17. The apparatus according to claim 16, wherein said sequence number processor is further configured to dynamically adjust said length of said sequence number to compensate for changes in said amount of jitter in said Internet Protocol based link.

18. An apparatus for synchronizing encrypted data in an Internet Protocol based network, comprising:
an encryption/decryption module configured to encrypt a data packet to be transmitted;
a sequence number processor in said encryption/decryption module configured to generate a sequence number associated with said encrypted data packet;
a transceiver module connected to said encryption/decryption module configured to transmit said encrypted data packet together with said sequence number via an Internet Protocol based link, wherein said sequence number processor is further configured to extract a sequence number from a received encrypted data packet, and said encryption/decryption module is further configured to decrypt said encrypted data packet based on a value of said extracted sequence number; and
an error detection module configured to check said decrypted data packet for errors and to cause an error message to be sent if errors are detected in a predetermined number of data packets, said error detection module being further configured to initiate a data recovery procedure upon detecting that errors have occurred in said predetermined number of data packets, wherein said sequence number processor is further configured to reset said sequence number to an initial value after initiation of said data recovery procedure and to issue a sequence number reset notification message after said sequence number is reset.
